(19) United States
(12) Patent Application Publication
(10) Pub. No.: US 2026/0200289 A1
(43) Pub. Date: Jul. 16, 2026

(54) HEATING APPARATUS FOR VEHICLE

(71) Applicants: YURA TECH CO., LTD., Sejong (KR); ESTRA AUTOMOTIVE SYSTEMS CO., LTD., Daegu (KR)

(72) Inventors: Yong Jun PARK, Cheonan-si (KR); Keun Hyeong KIM, Sejong (KR); Sung Won KANG, Changwon-si (KR)

(21) Appl. No.: 19/134,827

(22) PCT Filed: Nov. 8, 2023
(86) PCT No.: PCT/KR2023/017895

§ 371 Date: Jun. 2, 2025

(30) Foreign Application Priority Data
Dec. 5, 2022 (KR) 10-2022-0168067

(51) Int. Cl. B60H 1/22; F24H 1/00; F24H 9/00

(52) U.S. Cl. CPC B60H 1/2221; F24H 1/009; F24H 9/0015

(57) ABSTRACT

A heating apparatus for a vehicle, according to an embodiment of the present invention, comprises: a body in which an accommodation space open on one side thereof is formed; a cover which is provided at the open surface of the accommodation space and at which a heating part for providing heat is formed; and inlet and outlet parts which are connected to the body and circulate a heat transfer medium through the accommodation space, wherein a heat dissipation protrusion is further formed in the body, the heat dissipation protrusion protruding from the accommodation space and coming into contact with the heating part so as to discharge heat indirectly to the heat transfer medium, thereby preventing overheating. Accordingly, the present invention improves product durability and reliability.

### TECHNICAL FIELD

The present invention relates to a heating apparatus for a vehicle, and more particularly, to a heating apparatus for a vehicle, which supplies heat to a circulating heat transfer medium.

### BACKGROUND ART

An electric heating apparatus is used as a heat source in a vehicle to generate heat, transfer the generated heat to a liquid heat transfer medium, and ultimately heat air through the heated heat transfer medium to transfer the heated air to a destination, such as the vehicle's passenger compartment.

Here, the heating apparatus for the vehicle provides a heating part over the entire surface area of one surface that is in contact with the heat transfer medium to enable effective heat transfer to the heat transfer medium. For this, the heating part is formed using printed circuit technologies, and power has to be supplied to the entire heating part through a limited power supply part, and thus, the heating part inevitably has a bending section that is bent at one side.

Thus, there was a problem in that a charge density of the heating part at the inside of the banding section increases to cause a hot spot at which the temperature rises above a predetermined temperature, thereby reducing durability and lifespan of a product.

### DISCLOSURE OF THE INVENTION

### Technical Problem

An embodiment of the present invention has been devised to solve the above problems, and an object of the present invention is to provide a heating apparatus for a vehicle, in which a heat dissipation protrusion that is in contact with a bending section of a heating part is provided to prevent a hot spot from occurring, thereby providing more improved durability and reliability of a product.

### Technical Solution

A heating apparatus for a vehicle according to an embodiment of the present invention includes: a body in which an opened accommodation space is defined at one side thereof; a cover which is installed on an opened surface of the accommodation space and in which a heating part configured to provide heat is provided; inlet and outlet parts connected to the body to circulate a heat transfer medium into the accommodation space, wherein the body further comprises a heat dissipation protrusion that protrudes from the accommodation space and is in contact with the heating part to indirectly release the heat to the heat transfer medium, thereby preventing overheating.

The heating part may have a straight section and a bending section bent from a distal end of the straight section to generate heat on an entire side surface of the cover, wherein the straight section and the bending section may be repeated, and the heat dissipation protrusion may be in contact with the bending section.

A first printed circuit, which has one side connected to a negative electrode terminal and is provided with a first straight section disposed in a circulation direction and a first bending section connecting the different first straight sections to each other, and a second printed circuit, which has one side connected to a positive electrode terminal and is provided with a second straight section disposed in an extension direction and a second bending section connecting the different second straight sections to each other, may be connected to the heating part to provide heat the entire area of the accommodation space.

The heating part may be provided with a second printed circuit disposed at each of both sides of the first printed circuit and disposed between the first printed circuits to be respectively connected to the first printed circuits, and the heat dissipation protrusion may be in contact with the bending section of the first printed circuit disposed to face the second printed circuit.

The accommodation space may include: inlet and outlet spaces, which communicate with the inlet and outlet ports to allow the heat transfer medium to be introduced and discharged in an extension direction; and a circulation space defined between the inlet and outlet spaces to allow the heat transfer medium to move in a circulation direction, and wherein the heat dissipation protrusion may protrude to the circulation space.

The heat dissipation protrusion may include: a first heat dissipation protrusion that is in contact with the bending section; and a second heat dissipation protrusion that is in contact with the straight section, wherein the different second heat dissipation protrusions adjacent to the one first heat dissipation protrusion may be disposed symmetrical with each other.

The heat dissipation protrusion may have a diameter of 20% or more and 100% of less of a line width of the first printed circuit, and a horizontal distance of the heat dissipation protrusion from each of the different heat dissipation protrusions adjacent to each other may be 200% or more of the diameter.

The heat dissipation protrusion may have a heat dissipation groove that is recessed in a certain pattern along an outer circumferential surface to increase in contact area with the heat transfer medium.

### ADVANTAGEOUS EFFECTS

As described above, according to the technical solution of the present invention, the various effects including the following facts may be expected. However, it is unnecessary to allow all of the following effects to be exerted.

The heating apparatus for the vehicle according to the present invention may be provided with the heating part having the straight section and the bending section to secure the contact area between the heat transfer medium and the heating part, thereby enabling the heat transfer to the heat transfer medium.

Here, the heat dissipation protrusion that is in contact with the heating part may be provided to prevent the hot spot phenomenon in which the temperature of the heating part rises to the temperature higher than the predetermined temperature from occurring, thereby improving the durability of the product and the reliability.

In addition, the heat dissipation protrusion may include the first heat dissipation protrusion having the bending section and the second heat dissipation protrusion having the straight section. Here, the different second heat dissipation protrusions that are adjacent to the one first heat dissipation protrusion may be symmetrically disposed to prevent the interference with the flow of the heat transfer medium even while generating the turbulence of the heat transfer medium, thereby improving the head dissipation effect.

### BRIEF DESCRIPTION OF THE DRAWINGS

FIG. 1 is a perspective view of a heating apparatus for a vehicle according to an embodiment of the present invention.

FIG. 2(a) is an exploded perspective view, and FIG. 2(b) is a perspective when viewed in a direction different from that of FIG. 2(a).

FIG. 3 is one side view of a cover of FIG. 2.

FIG. 4 is a view illustrating a state in which a heat dissipation protrusion according to an embodiment is projected in a plan view of FIG. 1.

FIG. 5 is a view illustrating a flow of a heat dissipation medium in FIG. 4.

FIG. 6 is a cross-sectional perspective view in a direction VI-VI in FIG. 1.

FIG. 7(a) is a photograph obtained by photographing a heating part of FIG. 3 using a thermal imaging camera, and

FIG. 7(b) is a photograph obtained by photographing the heating part using the thermal imaging camera in a state in which the heat dissipation protrusion is not provided.

FIG. 8 is a view illustrating a state in which a heat dissipation protrusion according to another embodiment is provided in FIG. 4.

### MODE FOR CARRYING OUT THE INVENTION

Hereinafter, specific embodiments will be described in detail with reference to the drawings. However, in order not to distract from the gist of the present invention, descriptions of known functions or configurations are omitted.

In addition, for convenience of explanation, a direction in which a heat transfer medium is introduced/discharged into/from a heating apparatus for a vehicle is defined as an extension direction, a direction in which the heat transfer medium flows through a circulation space is defined as a circulation direction, and a direction perpendicular to both the extension direction and the circulation direction is defined as an axial direction.

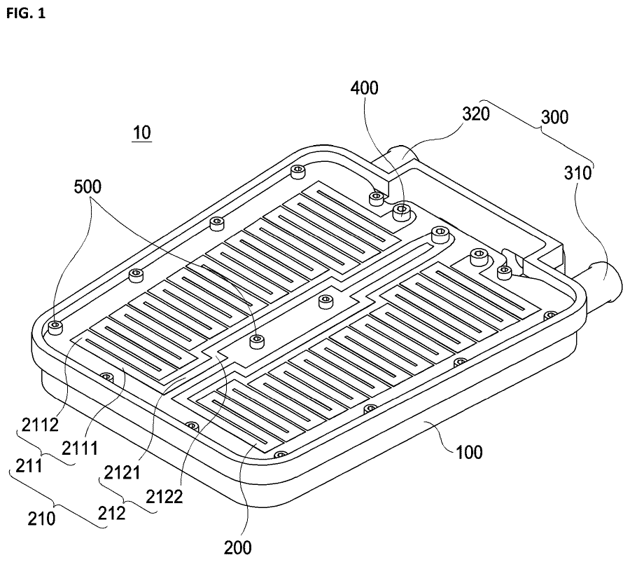

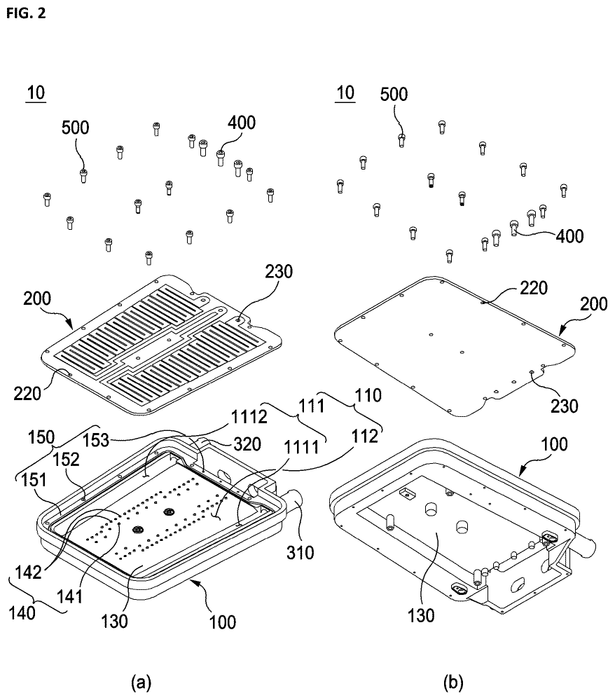

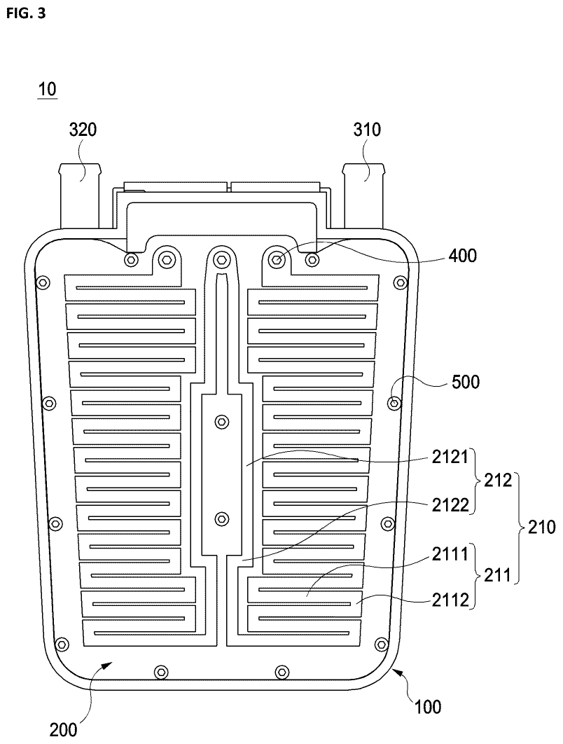

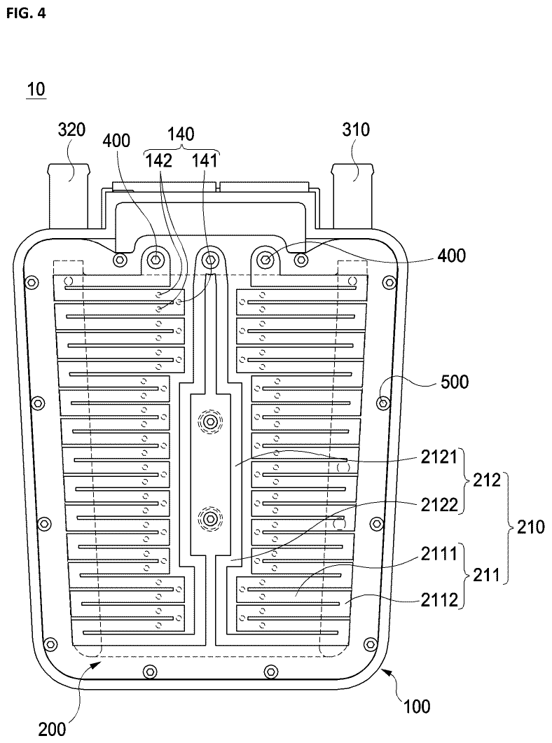

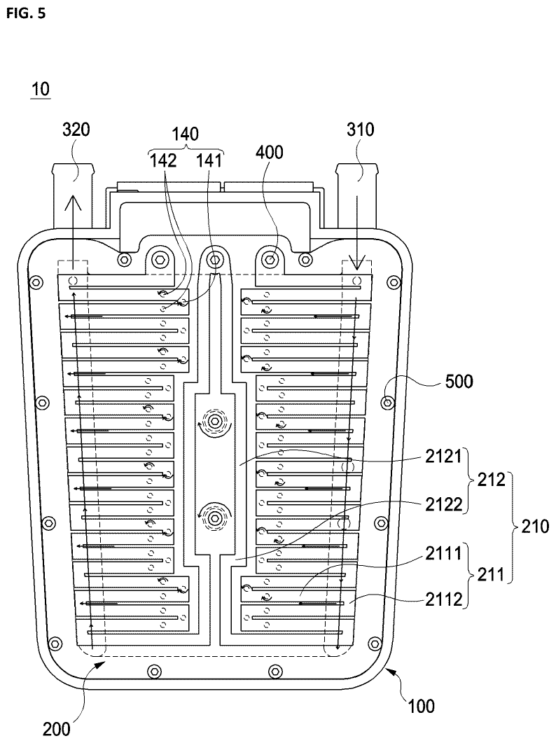

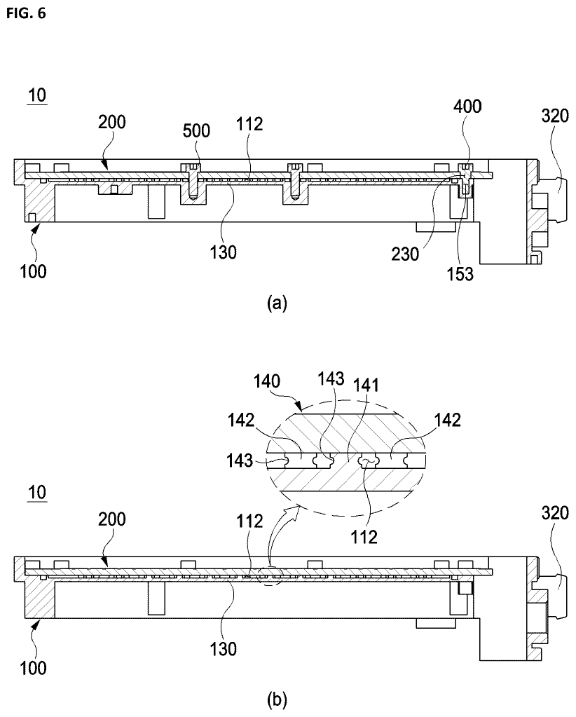

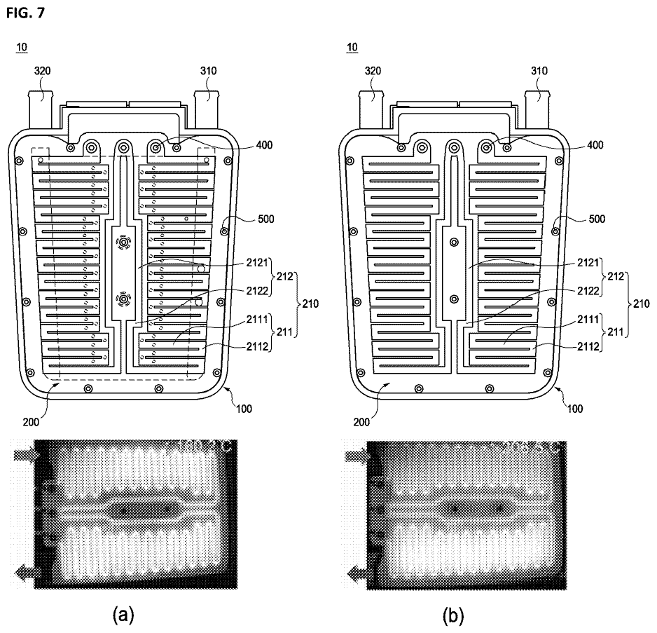

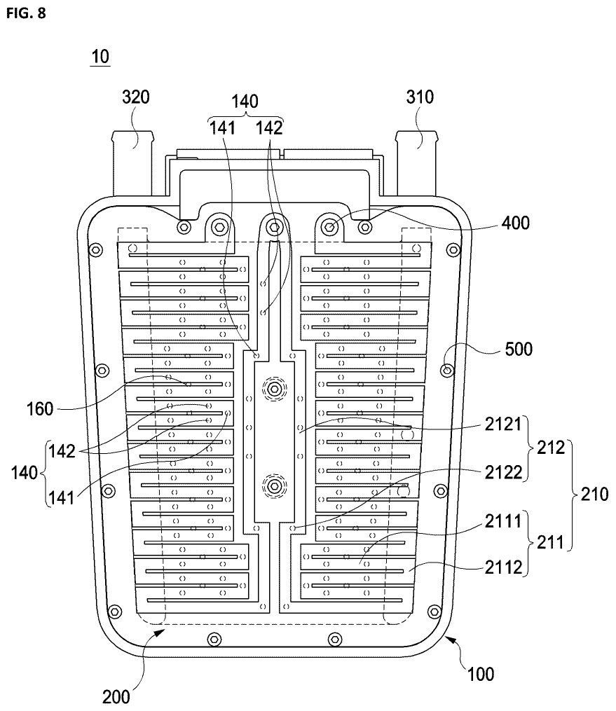

FIG. 1 is a perspective view of a heating apparatus for a vehicle according to an embodiment of the present invention, FIG. 2(a) is an exploded perspective view, and FIG. 2(b) is a perspective when viewed in a direction different from that of FIG. 2(a), FIG. 3 is one side view of a cover of FIG. 2, FIG. 4 is a view illustrating a state in which a heat dissipation protrusion according to an embodiment is projected in a plan view of FIG. 1, FIG. 5 is a view illustrating a flow of a heat dissipation medium in FIG. 4, FIG. 6 is a cross-sectional perspective view in a direction VI-VI in FIG. 1, FIG. 7(a) is a photograph obtained by photographing a heating part of FIG. 3 using a thermal imaging camera, and FIG. 7(b) is a photograph obtained by photographing the heating part using the thermal imaging camera in a state in which the heat dissipation protrusion is not provided, and FIG. 8 is a view illustrating a state in which a heat dissipation protrusion according to another embodiment is provided in FIG. 4.

Referring to FIGS. 1 to 8, a heating apparatus for the vehicle 10 according to an embodiment of the present invention includes a body 100 having an accommodation space 110 opened to one side, a cover 200 installed on an opened surface of the accommodation space 110 and provided with a heating part 210 that provides heat, and inlet and outlet parts connected to the body 100 to circulate a heat transfer medium into the accommodation space 110, and the body 100 further includes a heat dissipation protrusion 140 that is in contact with the heating part 210 to protrude from the accommodation space 110 so as to indirectly release the heat to the heat transfer medium, thereby preventing overheating.

The body 100 is provided with the accommodation space 110 having the opened one side surface, a first connection hole which is defined at one side of the body 100 and to which a connection terminal 400 is coupled, a stepped part 130 that defines a circulation space 112, the heat dissipation protrusion 140 protruding to the accommodation space 110, and a space which is provided as a coupling part 150, on which a cover 200 is seated, and in which a heat circulation medium is circulated.

Particularly, the accommodation space 110 may include an inlet space 1111 connected to an inlet port 310 to extend in the extension direction, an outlet space 1112 connected to an outlet port 320 to extend in the extension direction, and the circulation space 112 defined between the inlet space 1111 and the outlet space 1112 to allow the heat transfer medium to move in the circulation direction and receiving the heat from the heating part 210, and thus, the heat transfer medium may effectively receive the heat while moving in the accommodation space 110.

The stepped part 130 is a surface of the body 100, which protrudes into the accommodation space 110 with respect to the inlet space 1111 and the outlet space 1112 to provide a height difference with the circulation space 112. In summary, the circulation space 112 becomes narrower than that of each of the inlet space 1111 and the outlet space 1112 in the axial direction due to the stepped part 130.

Thus, an amount of heat transfer medium that is in contact with the heating part 210 in a moment to allow the entire heat transfer medium to uniformly receive heat, and simultaneously, to generate a pressure difference so that the heat transfer medium smoothly moves in the circulation direction.

In addition, the heat dissipation protrusion 140 that protrudes into the circulation space 112 and is in contact with the heating part 210 is provided on an inner surface of the stepped part 130 to allow the heat generated from the heating part 210 to be indirectly transferred to the heat transfer medium, thereby providing an additional heat dissipation effect.

Specifically, the heat dissipation protrusion 140 is constituted by a first heat dissipation protrusion 141 disposed in the bending section of the heating part 210 and a second heat dissipation protrusion 142 disposed in the straight section of the heating part 210. The first heat dissipation protrusion 141 is connected to the bending section of the heating part 210 to prevent a hot spot phenomenon that occurs while a charge density increases due to bending, and the second heat dissipation protrusion 142 improves the heat dissipation effect of the first heat dissipation protrusion 141 and simultaneously interferes with a flow of the heat transfer medium to enable more efficient heat transfer.

Here, it is preferable that the second heat dissipation protrusions 142 adjacent to one first heat dissipation protrusion 141 are disposed symmetrically at the same distance to provide a triangular arrangement with the first heat dissipation protrusion 141, thereby actively mix the heat transfer medium around the banding section, thereby improving the heat dissipation effect.

In addition, it is preferable that a diameter of each of the first and second heat dissipation protrusions 141 and 142 is 20% or more and 100% or less of a width of the heating part 210, and a distance in the circulation direction of the different first and second heat dissipation protrusions 141 and 142 adjacent to each other is 200% or more of the diameter.

Here, the diameter of each of the first and second heat dissipation protrusions 141 and 142 is limited to 20% or more of the width of the heating part 210 to ensure productivity by providing a size larger than that which is formed by an injection or casting mold, and the diameter is limited to 100% or less of the width of the heating part 210 to prevent the first and second heat dissipation protrusions 141 and 142 from being in contact with the cover 200 on which the heating part 210 is not provided, thereby more effectively preventing the hot spot phenomenon of the heating part 210.

In addition, the reason in which the distance in the circulation direction of the different first and second heat dissipation protrusions 141 and 142 is limited to 200% or more of the diameter is to prevent the flow of the heat transfer medium from being obstructed by a relative increase in differential pressure when the interference occurs due to the different first and second heat dissipation protrusions 141 and 142 while the heat transfer medium moves along an outer surface of each of the first and second heat dissipation protrusions 141 and 142 to generate rotational force.

In summary, the heat dissipation protrusion 140 may provide the first heat dissipation protrusion 141 disposed in the bending section and the second heat dissipation protrusion 142 disposed in the straight section to directly receive the heat from the heating part 210 and release the heat to the heat transfer medium, thereby preventing the hot spot phenomenon in which the heating part 210 has a temperature higher than a predetermined temperature and also allowing the smooth mixing of the heat transfer medium around the bending section to enable the efficient heat transfer.

The coupling part 150 is provided with a seating end 151 disposed along an inner circumferential surface of the accommodation space 110 so that the cover 200 is seated and a first coupling hole 152 and a first connection hole 153, which are defined in the seating end 151. The coupling part 150 is stably fixed to the body 100 by a coupling member 500 and a connection terminal 400 after the cover 200 is seated on one side of the body 100 to seal the accommodation space 110.

Here, the first coupling hole 152 simply means a hole in which the coupling member 500 that passes through the body 100 and the cover 200 at the same time is coupled, and the first connection hole 153 means a hole in which the connection terminal 400 that supplies power to the heating part 210 is coupled while simultaneously passing through the body 100 and the cover 200.

In addition, if necessary, a circular protrusion 160 may be further provided by protruding into the circular space 112. The circular protrusion 160 is the same as the first and second heat dissipation protrusions 141 and 142 in that the circular protrusion 160 extends in the axial direction and is in contact with the cover 200, but it is different in that the circular protrusion 160 is not in contact with the heating part 210 and is in contact with the cover 200, on which the heating part 210 is not provided, to improve the heat transfer efficiency by allowing the heat transfer medium to be mixed more actively in the circulation space 112 rather than the heat dissipation effect.

However, in order to prevent the circulation of the heat transfer medium from being obstructed by the circulation protrusion 160, it is preferable that the size of the circulation protrusion 160 is the same as that of each of the first and second heat dissipation protrusions 141 and 142, and it is also preferable that the distance in the circulation direction with the adjacent first and second heat dissipation protrusions 141 and 142 is at least 200% of the diameter of each of the circulation protrusion 160 and the first and second heat dissipation protrusions 141 and 142.

In addition, it is preferable that the circulation protrusion 160 is disposed between the second heat dissipation protrusions 142, that is, between different straight sections, and if a distance between the straight sections is narrower than the width of the heating part 210, the circular protrusions 160 may be in contact with the surrounding straight sections, and this is not a problem when considering that functions of the first and second heat dissipation protrusions 141 and 142 and the circular protrusions 160 are different.

In summary, the heating apparatus for the vehicle 10 according to the present invention provides the heat dissipation protrusion 140 that is in direct contact with the heating part 210 to effectively prevent the hot spot phenomenon that is caused by the increase in charge density occurring in the banding section, thereby significantly improving durability and reliability of a product.

In addition, the circular protrusion 160 may be provided as necessary to maximize the mixing effect of the heat transfer medium, thereby improving the heat transfer efficiency.

The cover 200 is coupled to an opening of the accommodation space 110 to seal the accommodation space 110, and the heating part 210 is printed on one side to transfer the heat to the heat transfer medium through the cover 200. In addition, the cover 200 may have a second connection hole 220 that communicates with the first connection hole 152 and a second connection hole 230 that communicates with the first connection hole 153 along an edge thereof to stably couple the cover 200 to the body 100 and supply power to the heating part 210.

Here, the heating part 210 is provided on the entire side surface of the cover 200 by repeatedly providing the straight section and the bending section so that the heat is generated on the entire side of the cover 200 to enable the effective heat transfer to the heat transfer medium.

Specifically, the heating part 210 is provided with a first printed circuit 211 connected to a negative electrode of the power supply part and having a first straight section 2111 disposed in the circulation direction and a first bending section 2112 connecting different first straight sections to each other, and a second printed circuit 212 connected to a positive electrode of the power supply part and having a second straight section 2121 disposed in the extension direction and a second bending section 2122 connecting different second straight sections 2121 to each other.

More preferably, the first printed circuit 211 is disposed at each of both sides of one side surface of the cover 200, and a portion that is disposed between the first printed circuits 211 and has one side, at which the first printed circuit 211 and the second printed circuit 212 are disposed, so that the first bending section 2112 and the second bending section 2122 are adjacent thereto, may be minimized to minimize the increase in temperature due to the hot spot phenomenon, and simultaneously, to minimize a volume ratio of an area of the heating part 210 to the total area of the one side surface of the cover 200.

In the state where the cover 200 is seated on the seating end 151, the second coupling hole 220 communicates with the first coupling hole 152, and the second connection hole 230 communicates with the second connection hole 230 to seal the accommodation space 110 by the coupling member 500 that passes through the first and second coupling holes 152 and 220 at the same time and supply the power to the heating part 210 by the connection terminal 400 that passes through the first and second connection holes 153 and 230 at the same time.

Thus, the heating apparatus for the vehicle 10 according to the present invention provides the second printed circuit 212 that secures the area occupied by the heating part 210 through the first printed circuit 211, which is provided by repeating the first straight section 2111 and the second bending section 2122, and also, mainly extends in the extension direction between the first printed circuits 211 to minimize the phenomenon in which the different first bending sections 2112, and the first bending section 2112 and the second bending section 2122 are adjacent to each other, thereby reducing the increase in temperature due to the hot spot.

The inlet and outlet ports 300 are connected to one side of the body 100 to allow the heat transfer medium to be circulated from the outside to the accommodation space 110 and from the accommodation space 110 to the outside. For this, the inlet port 310 is connected to one side of the body 100 to communicate with the inlet space 1111, and the outlet port 320 is connected to one side of the body 100 to communicate with the outlet space 1112.

Therefore, the heating apparatus for the vehicle 10 according to the present invention improves the heating efficiency by enabling the effective heat transfer through the circulating heat transfer medium and also reduces the temperature rise rate due to the hot spot that inevitably occurs in the heating part 210, thereby improving the durability of the product and extending its lifespan.

It also provides improved product reliability by preventing the reliability and stability of the product from being deteriorated by the persistent hot spots.

Although the exemplary embodiment of the present invention is illustratively described, the technical scope of the present invention is not limited to only the specific embodiment, and thus all suitable modifications and equivalents coming with the scope of the appended claims.

1. A heating apparatus for a vehicle, comprising:
a body in which an opened accommodation space is defined at one side thereof;
a cover which is installed on an opened surface of the accommodation space and in which a heating part configured to provide heat is provided;
inlet and outlet parts connected to the body to circulate a heat transfer medium into the accommodation space,
wherein the body further comprises a heat dissipation protrusion that protrudes from the accommodation space and is in contact with the heating part to indirectly release the heat to the heat transfer medium, thereby preventing overheating.

2. The heating apparatus of claim 1, wherein the heating part has a straight section and a bending section bent from a distal end of the straight section to generate heat on an entire side surface of the cover, wherein the straight section and the bending section are repeated, and
the heat dissipation protrusion is in contact with the bending section.

3. The heating apparatus of claim 2, wherein a first printed circuit, which has one side connected to a negative electrode terminal and is provided with a first straight section disposed in a circulation direction and a first bending section connecting the different first straight sections to each other, and a second printed circuit, which has one side connected to a positive electrode terminal and is provided with a second straight section disposed in an extension direction and a second bending section connecting the different second straight sections to each other, are connected to the heating part to provide heat the entire area of the accommodation space.

4. The heating apparatus of claim 3, wherein the heating part is provided with a second printed circuit disposed at each of both sides of the first printed circuit and disposed between the first printed circuits to be respectively connected to the first printed circuits, and
the heat dissipation protrusion is in contact with the bending section of the first printed circuit disposed to face the second printed circuit.

5. The heating apparatus of claim 2, wherein the accommodation space comprises:
inlet and outlet spaces, which communicate with the inlet and outlet ports to allow the heat transfer medium to be introduced and discharged in an extension direction; and
a circulation space defined between the inlet and outlet spaces to allow the heat transfer medium to move in a circulation direction, and
wherein the heat dissipation protrusion protrudes to the circulation space.

6. The heating apparatus of claim 1, wherein the heat dissipation protrusion comprises:
a first heat dissipation protrusion that is in contact with the bending section; and
a second heat dissipation protrusion that is in contact with the straight section,
wherein the different second heat dissipation protrusions adjacent to the one first heat dissipation protrusion are disposed symmetrical with each other.

7. The heating apparatus of claim 3, wherein the heat dissipation protrusion has a diameter of 20% or more and 100% of less of a line width of the first printed circuit.

8. The heating apparatus of claim 7, wherein a horizontal distance of the heat dissipation protrusion from each of the different heat dissipation protrusions adjacent to each other is 200% or more of the diameter.

9. The heating apparatus of claim 1, wherein the heat dissipation protrusion has a heat dissipation groove that is recessed in a certain pattern along an outer circumferential surface to increase in contact area with the heat transfer medium.
